(19) United States
(12) Patent Application Publication
(10) Pub. No.: US 2019/0187611 A1
(43) Pub. Date: Jun. 20, 2019

(54) IMAGE FORMING APPARATUS

(71) Applicant: Konica Minolta Inc., Tokyo (JP)

(72) Inventors: Shinichi KAWABATA, Tokyo (JP); Akihiko KAKITA, Tokyo (JP)

(21) Appl. No.: 16/220,487

(22) Filed: Dec. 14, 2018

(30) Foreign Application Priority Data
Dec. 18, 2017 (JP) 2017-241349

(51) Int. Cl. G03G 21/20; G03G 15/08

(52) U.S. Cl. CPC G03G 21/203; G03G 15/0258; G03G 15/0898; G03G 21/206

(57) ABSTRACT

An image forming apparatus includes: a charger that charges a photoreceptor; a developing part that develops a toner image on the charged and exposed photoreceptor; a detector that detects at least one of humidity, ozone generated from the charger, and toner scattered from the developing part; and a processor that performs a process of reducing at least one of the detected humidity, ozone, and scattered toner, when the at least one of the detected humidity, ozone, and scattered toner is equal to or higher than a predetermined threshold value, predetermined threshold values having been set beforehand for humidity, ozone, and scattered toner.

### CROSS REFERENCE TO RELATED APPLICATION

The present application claims priority under 35 U.S.C. § 119 to Japanese patent Application No. 2017-241349, filed on Dec. 18, 2017, is incorporated herein by reference in its entirety.

### BACKGROUND

### Technological Field

The present invention relates to an image forming apparatus.

### Description of the Related art

There are conventional image forming apparatuses such as an electrophotographic complex machine that forms an image on a paper sheet using toner. In an image forming apparatus, scattering or leakage of toner occurs during a process such as development, and ozone is generated by the discharge during the process of charging the photoreceptors (drums). The generation of toner and ozone results in a mixed odor of an ultra fine particles (UFP) odor caused by the toner as UFP and an ozone odor caused by the ozone.

To counter this, there is a known image forming apparatus that eliminates and deodorizes odor components generated from the resin, the toner, and the carrier, having a structure in which microorganisms are contained in a porous stirring member or a hollow stirring member with porous surfaces (see JP 2009-286448 A).

The image forming apparatus of JP 2009-286448 A is designed to eliminate generated odor components, but is not designed to prevent generation of odor components.

The following aspects of an image forming apparatus are also known: (1) in a high-humidity environment (in moisture), (2) ozone generated in a charger and (3) scattered toner from a developing machine chemically react with each other because of the high voltage at the charger, and as a result, (4) unusual odor (butanol) is generated. The contribution of the (3) scattered toner to the generation of the (4) butanol is greater than that of the (1) high-humidity environment and the (2) ozone.

Even if an ozone filter is used to eliminate the (4) butanol, the ozone filter eliminates the unusual odor components with its adsorptive properties. Therefore, once the unusual odor components adsorb onto the filter surface, the removal performance becomes ineffective, and the ozone filter becomes poorer in filter durability. As a result, the frequency of ozone filter exchange and the frequency of dispatch of a service person increase, the labor costs become higher, and the component costs also become higher due to the larger surface area. For example, in a case where the ozone filter has a shape that is 80 mm in length, 40 mm in width, and 15 mm in thickness, and the ozone decomposing performance maintains a level of 90% when printing has been performed on about 600,000 paper sheets, the ozone filter against unusual odor drops to such a level that the ozone filter needs to be replaced when printing has been performed on about 100,000 paper sheets.

### SUMMARY

An object of the present invention is to prevent generation of unusual odor, and lower the labor costs and the component costs required in removing unusual odor.

To achieve the abovementioned object, according to an aspect of the present invention, an image forming apparatus reflecting one aspect of the present invention comprises: a charger that charges a photoreceptor; a developing part that develops a toner image on the charged and exposed photoreceptor; a detector that detects at least one of humidity, ozone generated from the charger, and toner scattered from the developing part; and a processor that performs a process of reducing at least one of the detected humidity, ozone, and scattered toner, when the at least one of the detected humidity, ozone, and scattered toner is equal to or higher than a predetermined threshold value, predetermined threshold values having been set beforehand for humidity, ozone, and scattered toner.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view of the structure of an entire image forming apparatus according to an embodiment of the present invention;

FIG. 2 is a functional block diagram showing the control configuration of the image forming apparatus;

FIG. 3 is a schematic view of a collection mechanism;

FIG. 4 is a flowchart showing a first unusual odor prevention process;

FIG. 5A is a diagram showing a prediction judgment table;

FIG. 5B is a diagram showing a process table; and

FIG. 6 is a flowchart showing a second unusual odor prevention process.

### DETAILED DESCRIPTION OF EMBODIMENTS

Hereinafter, one or more embodiments and modification of the present invention will be described with reference to the drawings. However, the scope of the invention is not limited to the disclosed embodiments and examples shown in the drawings.

### 1. Embodiment

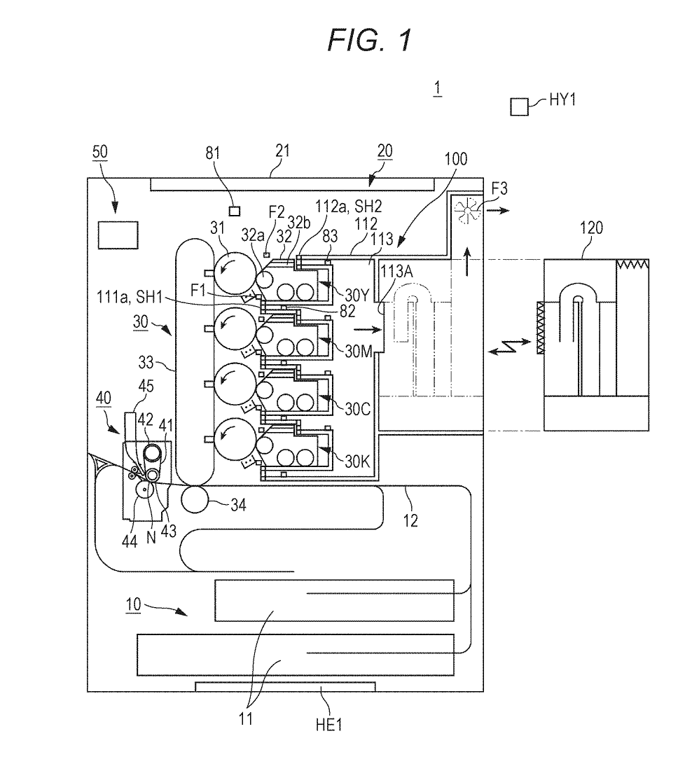

Referring to FIG. 1 to FIG. 4, an embodiment according to the present invention is described.

### 1-1. Structure of an Entire Image Forming Apparatus

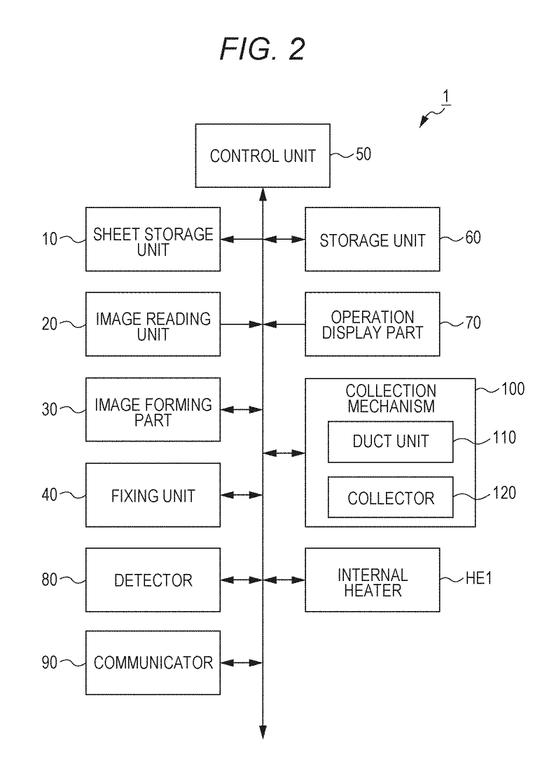

Referring first to FIG. 1 and FIG. 2, the structure of an entire image forming apparatus 1 according to this embodiment is described. FIG. 1 is a schematic view of the structure of the entire image forming apparatus 1. FIG. 2 is a functional block diagram showing the control configuration of the image forming apparatus 1.

As shown in FIG. 1, the image forming apparatus 1 is a tandem-type color-image forming apparatus that forms images on paper sheets by an electrophotographic method, and overlap toners of four colors, which are yellow (Y), magenta (M), cyan (C), and black (K), on one another.

As shown in FIG. 2, the image forming apparatus 1 includes a sheet storage unit 10, an image reading unit 20, an image forming part 30, a fixing unit 40, a control unit 50, a storage unit 60, an operation display part 70, a detector 80, a communicator 90, a collection mechanism 100, and an internal heater HE1, for example. The respective components of the image forming apparatus 1 are connected via a bus. As shown in FIG. 1, the image forming apparatus 1 also includes an indoor hygrometer HY1 that is communicatively connected via the communicator 90.

The sheet storage unit 10 is disposed at a lower portion of the image forming apparatus 1, and trays 11 corresponding to the sizes and types of paper sheets are provided therein. In the sheet storage unit 10 under the control of the control unit 50, a paper sheet is supplied from a tray 11, and is conveyed to a conveying unit 12. The conveying unit 12 then conveys the paper sheet to the image forming part 30 and the fixing unit 40.

Under the control of the control unit 50, the image reading unit 20 reads an image of a document conveyed by a document conveying unit (not shown) or a document placed on a document table 21, and then generates image data. The image reading unit 20 also performs processing such as shading correction, dithering, or compression on image data generated through A-D conversion, and stores the processed image data into a RAM of the control unit 50 described later. The image data is not necessarily data that is output from the image reading unit 20, but may be data that is received from an external device such as a personal computer or another image forming apparatus connected to the communicator 90 described later.

The image forming part 30 forms an image on a paper sheet, in accordance with an image forming job (hereinafter simply referred to as a “job”). The image forming part 30 includes four image forming units 30Y, 30M, 30C, and 30K corresponding to the respective color components Y, M, C, and K, an intermediate transfer belt 33, and a transfer roller 34.

Each of the image forming units 30Y, 30M, 30C, and 30K includes a drum-like photoreceptor 31, a developing part 32 and a charger 35 disposed around the photoreceptor 31, an exposure unit and a cleaning unit (not shown), and the like.

Under the control of the control unit 50, the charger 35 charges the photoreceptor 31 with charge pressure. When the charge voltage becomes higher, the charger 35 changes the oxygen in the apparatus into ozone by discharging. Because of this, ozone can be generated. The exposure unit emits laser light onto the charged photoreceptor 31, and thus, exposes the photoreceptor 31. As a result, an electrostatic latent image is formed on the photoreceptor 31. Under the control of the control unit 50, the developing part 32 supplies toner of a predetermined color (Y, M, C, or K) onto the exposed photoreceptor 31 with a charged developing roller 32a, and develops the electrostatic latent image formed on the photoreceptor 31.

The developing part 32 stores the toner for development and the carrier for transferring the toner onto the photoreceptor 31. However, the developing part 32 does not necessarily have this structure, and may be designed to store only the toner. The developing part 32 also includes a duct 32b as a path for attracting the toner scattered during the development.

Images (single-color images) formed with toner of Y, M, C, and K on the four photoreceptors 31 corresponding to Y, M, C, and K, respectively, are transferred onto the intermediate transfer belt 33 one by one from the respective photoreceptors 31 in a superimposing manner. As a result of this, a toner image having Y, M, C, and K as the color components is formed on the intermediate transfer belt 33. The intermediate transfer belt 33 is an endless belt wound around conveying rollers, and rotates with the respective conveying rollers. A bias of the opposite polarity from that of the toner is then applied to the transfer roller 34, so that the toner image formed on the intermediate transfer belt 33 is transferred onto a paper sheet.

In this embodiment, the image forming apparatus 1 includes the collection mechanism 100 for collecting toner scattered in the above described four image forming units 30Y, 30M, 30C, and 30K, and ozone generated from the charger 35. The collection mechanism 100 will be described later in detail.

Under the control of the control unit 50, the fixing unit 40 heats and pressurizes the paper sheet on which the toner image is formed by the image forming part 30. The fixing unit 40 includes an endless fixing belt 41 as a heating member, a heating roller 42, a fixing roller 43 disposed to face a pressure roller 44, the pressure roller 44, and an air separating unit 45. The fixing belt 41 is stretched by the heating roller 42 and the fixing roller 43. The heating roller 42 includes a heating means such as a halogen heater (not shown) that heats the fixing belt 41. The fixing roller 43 forms a nip portion N between the fixing belt 41 and the pressure roller 44.

In the above structure, when the pressure roller 44 is rotated in the counterclockwise direction by a drive means (not shown), the fixing belt 41, the heating roller 42, and the fixing roller 43 rotatively move or rotate in the clockwise direction. The fixing belt 41 is heated by the heating roller 42 in contact therewith, and the fixing roller 43 is also heated. The paper sheet on which the toner image is formed passes through the nip portion N, so that the paper sheet is heated and pressurized, and the toner image transferred onto the paper sheet is melted and fixed.

Under the control of the control unit 50, the air separating unit 45 blows air against the paper sheet being discharged from the nip portion N, to separate the paper sheet from the fixing belt 41. The air separating unit 45 includes a suction fan (not shown) that sucks air from the outside and sends the air toward the nip portion N, and a duct that is a path of the sent air. As the paper sheet is separated from the fixing belt 41 by the air separating unit 45, it is possible to separate the paper sheet without bringing a member such as a separating claw into contact with the surface of the fixing belt 41. Thus, the surface of the fixing belt 41 is damaged.

Meanwhile, the pressure roller 44 has a driving structure that can separate the pressure roller 44 from the fixing roller 43 under the control of the control unit 50. The fixing roller 43 and the pressure roller 44 are separated from each other, and the air blown by the air separating unit 45 passes through the separation portion, so that warm air can be sent toward the chargers 35 of the image forming part 30.

The control unit 50 includes a central processing unit (CPU) and a random access memory (RAM), for example. The CPU of the control unit 50 reads various kinds of programs, such as a system program and a processing program, from the storage unit 60, and loads the programs into the RAM. In accordance with the loaded programs, the CPU performs various kinds of processes, such as an image forming process and a toner collecting process.

The storage unit 60 is formed with a hard disk drive (HDD) or a nonvolatile semiconductor memory, for example. The storage unit 60 stores various kinds of programs such as the system program and the processing program to be executed by the control unit 50, and the data necessary for executing these programs. Particularly, the storage unit 60 stores a first unusual odor prevention program for performing a first unusual odor prevention process that will be described later.

The operation display part 70 includes a display part that displays various kinds of information on a display screen, and an operating unit that accepts inputs of various kinds of instructions from the user. Under the control of the control unit 50, the operation display part 70 displays display information on the display part, and outputs information that has been input to the operation unit, to the control unit 50.

The detector 80 detects various kinds of information, and outputs the detected information to the control unit 50. The detector 80 includes an internal humidity sensor 81, an ozone sensor 82, a particle counter 83, and an unusual odor detecting sensor 84. The internal humidity sensor 81 is disposed in the image forming apparatus 1. For example, the internal humidity sensor 81 is a detector that is disposed in the vicinity of the image forming part 30 (the chargers 35), and detects humidity. The ozone sensor 82 is a detector that is disposed in a suction duct 111 for each color in a duct unit 110 of the collection mechanism 100, for example, and detects the ozone concentration in the sucked air.

The particle counter 83 is a measuring instrument that is disposed in a suction duct 112 for each color in the duct unit 110 of the collection mechanism 100, for example, and counts toner particles as the fine particles in the sucked air. The particle counter 83 is of a light scattering type, and carries out measurement by measuring the intensity of light scattering from toner particles and extracting an electrical signal indicating the light intensity proportional to the size of the toner particles. The particle counter 83 may be of a light shielding type. The unusual odor detecting sensor 84 is a detector that is disposed in a flow path on the downstream side of a filter unit 126 of a collector 120 of the collection mechanism 100, for example, and detects the gas concentration of butanol as an unusual odor component.

The detector 80 also includes a voltage measuring unit that measures the charge pressure of the charger 35 of each color of the image forming units 30Y, 30M, 30C, and 30K. The high-voltage discharge condition of the charger 35 is determined by the voltage, the current, and the time. When the charge pressure as the voltage rises, the discharge amount of the charger 35 also increases, and the discharge further leads to an increase in the amount of generated ozone.

The communicator 90 is formed with a network card or the like, and is connected to a communication network including the Internet, a dedicated line, and the like. The communicator 90 exchanges information with external devices in the communication network. The external devices in the communication network may be a personal computer that transmits jobs to the image forming apparatus 1, a server device of a service center, and the like. The service person who maintains the image forming apparatus belongs to the service center. In accordance with the information being managed by the server device, the service person visits the location of installation of the image forming apparatus to be maintained, and then performs maintenance. The communicator 90 is also communicably connected to the indoor hygrometer HY1.

The internal heater HE1 is a heater that is disposed below the sheet storage unit 10, and raises the temperature inside the image forming apparatus 1, under the control of the control unit 50. The humidity inside the apparatus decreases with the temperature rise in the apparatus.

The indoor hygrometer HY1 is a humidity detector installed outside the image forming apparatus 1 in the room where the image forming apparatus 1 is installed. The indoor hygrometer HY1 measures the humidity in the room, and transmits humidity information to the control unit 50 via the communicator 90.

### 1-2. Structure of the Collection Mechanism

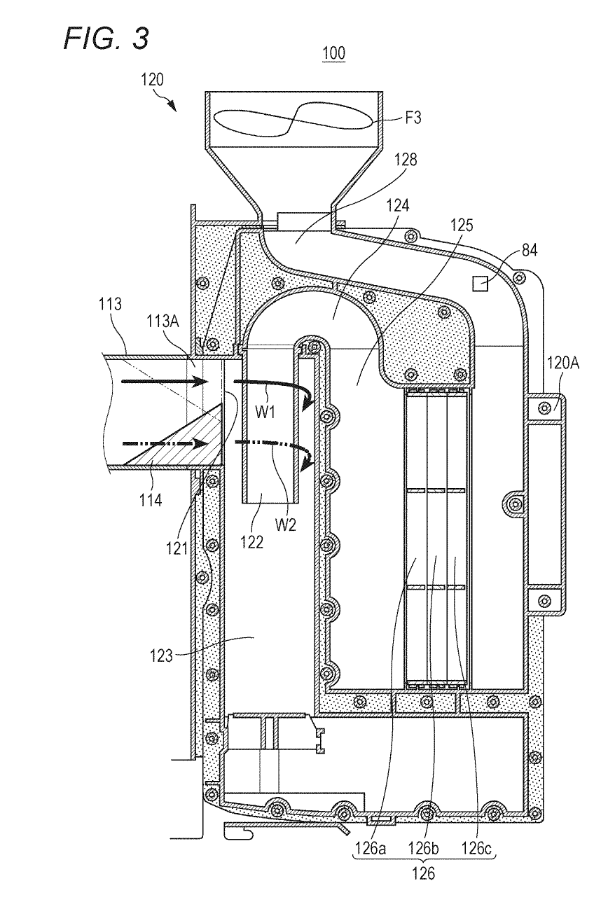

Next, the structure of the collection mechanism 100 is described, with reference to FIG. 1 and FIG. 3. FIG. 3 is a schematic view of the collection mechanism 100.

As shown in FIG. 2, the collection mechanism 100 includes: the duct unit 110 that forms an air passage for allowing air containing the ozone generated at the chargers 35 of the image forming units 30Y, 30M, 30C, and 30K and the toner scattered at the developing parts 32 of the image forming units 30Y, 30M, 30C, and 30K; and the collector 120 that collects and releases the toner and the ozone from the air flowing in from the duct unit 110.

### 1-2-1. Structure of the Duct Unit

The duct unit 110 includes: suction ducts 111 provided for the respective chargers 35 of the four image forming units 30Y, 30M, 30C, and 30K; suction ducts 112 provided for the respective developing parts 32 of the image forming units 30Y, 30M, 30C, and 30K; a common duct 113 that integrates the respective suction ducts 111 and 112; assist fans F1 and F2; and shutter portions SH1 and SH2.

The suction ducts 111 are disposed below the developing parts 32 of the respective colors. The inlet port 111a of each suction duct 111 is located in the vicinity of the charger 35 of each corresponding color, and sucks the air containing the ozone generated around the charger 35.

The suction ducts 112 are disposed above the developing parts 32 of the respective colors. A duct 32b is formed in the developing part 32 of each color. The inlet port of each duct 32b is located in the vicinity of the photoreceptor 31 and the developing roller 32a, and sucks the air containing the toner scattered around the photoreceptor 31 and the developing roller 32a. The inlet port 112a of the suction duct 112 of each color is located in the vicinity of the outlet of the duct 32b of each corresponding color, and sucks the air containing the toner scattering around the photoreceptor 31 and the developing roller 32a via the duct 32b.

The common duct 113 is formed in a hollow rectangular parallelepiped shape extending in the vertical direction. The common duct 113 functions to guide the toner-containing air to the collector 120, and serves as a receiving unit that allows the collector 120 to be detachably attached to the duct unit 110.

The common duct 113 has four communicating ports capable of connecting the suction ducts 111 and 112 to the side surface facing the four image forming units 30Y, 30M, 30C, and 30K. A connecting port 113A for connecting the inlet port 121 of the collector 120 thereto is formed on the surface of the common duct 113 on the side opposite from the side facing the four image forming units 30Y, 30M, 30C, and 30K.

The assist fans F1 are located in the vicinities of the chargers 35 of the respective colors, and, under the control of the control unit 50, blows the air in the vicinities of the chargers 35 of the respective colors toward the inlet ports 111a by virtue of rotation of an impeller unit (not shown). In this manner, the assist fans F1 assist the inflow of air at the inlet ports 111a. The assist fans F2 are located in the vicinities of the photoreceptors 31 and the developing rollers 32a of the respective colors, and, under the control of the control unit 50, blows the air in the vicinities of the photoreceptors 31 and the developing rollers 32a of the respective colors toward the inlet ports of the ducts 32b of the developing parts 32 by virtue of rotation of the impeller unit (not shown). In this manner, the assist fans F2 assist the inflow of air at the inlet ports 112a.

The shutter portions SH1 are provided in the inlet ports 111a of the respective colors, and, under the control of the control unit 50, open and close the cross-sectional areas of the air inlet paths of the inlet ports 111a of the respective colors. When the shutter portions SH1 are closed, the air passing through the suction ducts 111 are blocked. When the shutter portions SH1 are opened, air can pass through the suction ducts 111. The shutter portions SH2 are provided in the inlet ports 112a of the respective colors, and, under the control of the control unit 50, open and close the cross-sectional areas of the air inlet paths of the inlet ports 112a of the respective colors. When the shutter portions SH2 are closed, the air passing through the suction ducts 112 are blocked. When the shutter portions SH2 are opened, air can pass through the suction ducts 112.

As shown in FIG. 3, the collection mechanism 100 may include a shielding member 114 in the connecting port 113A. The shielding member 114 is provided on the lower surface inside the connecting port 113A, for example. Under the control of the control unit 50, the shielding member 114 protrudes upward from the lower surface inside the connecting port 113A, to narrow the cross-sectional area of the connecting port 113A. The shielding member 114 preferably has such a shape that guides the toner-containing air in a direction along a tangent line of a cyclone unit 122 that will be described later. In such a structure, the direction of the wind generated when the scattered toner is sucked is parallel to a tangent line of the cyclone unit 122 (as indicated by an arrow W1 in FIG. 3). Thus, the centrifugal force at the cyclone unit 122 becomes greater than that in a case where the direction of the wind is not parallel to a tangent line of the cyclone unit 122 (as indicated by an arrow W2 in FIG. 3), and separation efficiency can be increased.

### 1-2-2. Structure of the Collector

The collector 120 can be detachably attached to the common duct 113. The collector 120 includes the inlet port 121, the cyclone unit 122 communicating with the inlet port 121, a collecting unit 123, a reversing unit 124, an airflow path unit 125, the filter unit 126, the unusual odor detecting sensor 84, an outlet port 128, and a fan F3 that generates an air flow.

The shielding member 114 also preferably has such a shape that guides air toward the top portion of the cyclone unit 122. For example, the shielding member 114 may have a shape that increases in height in the direction from the suction ducts 111 toward the cyclone unit 122. In such a structure, the wind generated when the scattered toner is sucked is guided toward the top portion of the cylindrical cyclone unit 122 (as indicated by the arrow W1 in FIG. 3). Thus, the separation distance becomes longer than that in a case where the wind is not guided toward the top portion of the cyclone unit 122 (as indicated by the arrow W2 in FIG. 3), and separation efficiency can be increased.

The inlet port 121 is a receiving port that receives the toner- and ozone-containing air that has passed through the duct unit 110. When the collector 120 is attached to the common duct 113, the inlet port 121 faces the connecting port 113A of the common duct 113. As a result, the cyclone unit 122 communicates with the common duct 113 via the inlet port 121.

The cyclone unit 122 communicates with the space inside the common duct 113, and centrifugally separates the toner from the inflowing air. The cyclone unit 122 is formed in a cylindrical shape, and its axis coincides with the vertical direction (the direction in which gravity acts). This arrangement in which the axis is made to extend in the vertical direction is an optimum arrangement for separating the toner from the air.

The air that has entered the cyclone unit 122 flows in a tangential direction of the inner periphery of the cyclone unit 122. As a result, a swirling flow in which air circulates is generated inside the cyclone unit 122. The toner in the swirling flow moves in a radial direction because of the centrifugal force that acts when an object circulates. Accordingly, most of the toner is separated from the air (centrifugal separation). The separated toner falls downward due to its own weight, and is stored in the collecting unit 123. On the other hand, the air enters the reversing unit 124 provided above the cyclone unit 122.

The reversing unit 124 has a shape like a U-shaped pipe, and reverses the air from the cyclone unit 122 upside down, to guide the air to the airflow path unit 125.

The airflow path unit 125 communicates with the reversing unit 124, and guides the air flowing from the cyclone unit 122 via the reversing unit 124 downward. The filter unit 126 that filters the toner is disposed in the airflow path unit 125.

The filter unit 126 collects the small amounts of toner and ozone contained in the air having passed through the cyclone unit 122. Thus, the air that has passed through the filter unit 126 is cleaned. It is preferable to use more than one filter unit 126 and stack the filter units 126 in the air flowing direction. With this arrangement, the air cleaning effect becomes greater. For example, the filter units 126 may be a toner dust preventing filter unit 126a, an ozone catalyst filter unit 126b, and a toner dust preventing filter unit 126c that are arranged in this order from the side of the cyclone unit 122. The filter unit 126 may include an activated carbon filter. The unusual odor components sucked by the chargers 35 of the respective colors are collected by the ozone catalyst filter unit 126b (and the activated carbon filter).

The unusual odor detecting sensor 84 is provided in the flow path on the downstream side of the filter unit 126. The outlet port 128 is provided on the opposite side of the airflow path unit 125 from the cyclone unit 122. The outlet port 128 faces the fan F3, and the air that has passed through the filter unit 126 flows out from the outlet port 128 toward the fan F3. The fan F3 functions as an ozone fan that causes ozone to flow in through the inlet port 121, and as a suction fan that causes scattered toner to flow in through the inlet port 121. Under the control of the control unit 50, the fan F3 rotates the impeller unit to allow air to pass, and is capable of controlling the wind speed of the passing air by increasing or decreasing the rotation speed of the impeller unit.

The fan F3 is disposed above the outlet port 128. The fan F3 allows air to flow from the duct unit 110 to the collector 120. That is, the air sucked by the suction ducts 111 passes through the common duct 113, the cyclone unit 122, the reversing unit 124, the airflow path unit 125, the filter unit 126, and the outlet port 128, and after that, further passes through the fan F3, to be released to the outside of the image forming apparatus 1.

A handle 120A to be gripped when the collector 120 is attached to or detached from the common duct 113 is provided on the surface on the opposite side from the surface on which the inlet port 121 of the collector 120 is formed.

### 1-3. Operation of the Image Forming Apparatus

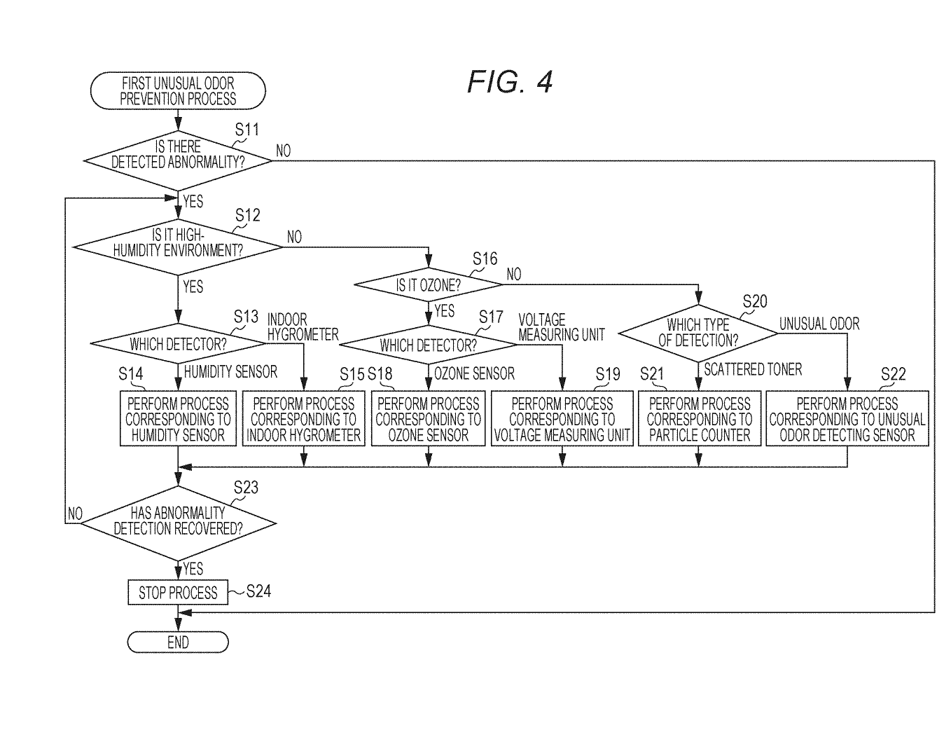

Referring now to FIG. 4, operation of the image forming apparatus 1 is described. FIG. 4 is a flowchart showing the first unusual odor prevention process.

In the image forming apparatus 1, an image forming process for forming an image on a paper sheet is performed in accordance with a job that is input from an external device via the communicator 90 or from the operation display part 70. Further, in the image forming apparatus 1, during an image forming process or in a standby state, the control unit 50 causes the collection mechanism 100 to perform a collecting process to collect the toner and the ozone scattered at the image forming part 30 (the image forming units 30Y, 30M, 30C, and 30K). In this collecting process, the fan F3 rotates at a normal rotation speed, the assist fans F1 and F2 are not operated, and the shutter portions SH1 and SH2 are opened, for example.

The first unusual odor prevention process to be performed during an image forming process or in a standby state in the image forming apparatus 1 is now described, with reference to FIG. 4. Butanol, which is an unusual odor component, is generated by a chemical reaction between ozone and scattered toner in a high-humidity environment when the chargers 35 have a high voltage. The first unusual odor prevention process is a process to take measures beforehand to prevent generation of an unusual odor component in a case where the cause of generation of an unusual odor component has been detected. The first unusual odor prevention process is performed at predetermined intervals, for example. In the image forming apparatus 1, with the trigger being the elapse of a predetermined period of time during an image forming process and in a standby state, the control unit 50 performs the first unusual odor prevention process in accordance with the first unusual odor prevention program stored in the storage unit 60.

First, the control unit 50 acquires detected information from the detector 80, and determines whether there is a detected abnormality by determining whether the detected information is equal to or higher than a predetermined threshold value indicating abnormality detection (step S11). More specifically, in step S11, the control unit 50 determines whether the detected information acquired from the internal humidity sensor 81 is equal to or higher than a predetermined threshold humidity indicating abnormality detection, determines whether the detected information acquired from the indoor hygrometer HY1 is equal to or higher than a predetermined threshold humidity indicating abnormality detection, determines whether the detected information acquired from the ozone sensor 82 of each color is equal to or higher than a predetermined threshold ozone concentration indicating abnormality detection, determines whether the detected information about the chargers 35 acquired from the voltage measuring unit of each color is equal to or higher than a predetermined threshold voltage indicating abnormality detection, determines whether the detected information acquired from the particle counter 83 of each color is equal to or higher than a predetermined threshold toner particle value, and determines whether the detected information acquired from the unusual odor detecting sensor 84 is equal to or higher than a predetermined threshold butanol concentration indicating abnormality detection. If any of the detected information is equal to or higher than the corresponding threshold value, the control unit 50 determines that there is a detected abnormality. If all the detected information is lower than the threshold values, it is determined that there is a detected abnormality.

If there is no detected abnormality (step S11: NO), the first unusual odor prevention process comes to an end. If there is a detected abnormality (step S11: YES), the control unit 50 determines whether the type of the abnormality detection is related to a high-humidity environment (a humidity abnormality detected by the internal humidity sensor 81 or the indoor hygrometer HY1) (step S12). In the case of a high-humidity environment (step S12: YES), the control unit 50 determines the detector that has detected the abnormality (step S13).

In a case where the detector that has detected the abnormality is the internal humidity sensor 81 (step S13: internal humidity sensor), the control unit 50 performs a process suitable for an abnormality detected by the internal humidity sensor 81 (step S14). In step S14, the control unit 50 separates the fixing roller 43 and the pressure roller 44 from each other and activates the air separating unit 45 to blow warm air to the chargers 35, and also activates the internal heater HE1 to lower the internal humidity, for example.

In a case where the detector that has detected the abnormality is the indoor hygrometer HY1 (step S13: indoor hygrometer), the control unit 50 performs a process suitable for an abnormality detected by the indoor hygrometer HY1 (step S15). In step S15, to indicate a warning to the user, the control unit 50 causes the operation display part 70 to display warning information to the effect that the indoor humidity is high, and there is a possibility of generation of unusual odor (butanol), for example. The user reads the warning information, and can lower the humidity in the room by driving the air-conditioner in the room or ventilating the room.

If the detected abnormality is not related to a high-humidity environment (step S12: NO), the control unit 50 determines whether the type of the detected abnormality is related to ozone (an ozone abnormality detected by the ozone sensor 82 or an abnormality detected by a voltage measuring unit in the charge pressure of the charger 35) (step S16). In the case of an ozone high-humidity environment (step S16: YES), the control unit 50 determines the detector that has detected the abnormality (step S17).

In a case where the detector that has detected the abnormality is the ozone sensor 82 (step S17: ozone sensor), the control unit 50 performs a process suitable for an abnormality detected by the ozone sensor 82 (step S18). In step S18, to reduce the generation of ozone, the control unit 50 lowers the pages per minute (PPM: the number of pages printed per minute) in image formation, for example. To have the ozone sucked quickly and cause the ozone catalyst filter unit 126b to collect the ozone, the control unit 50 increases the wind speed of the fan F3, switches on operation of the assist fans F1, opens the shutter portions SH1, and closes the shutter portions SH2. It is preferable to switch on the operation of the assist fans F1 and open/close the shutter portions SH1 and SH2 in accordance with the color in which the abnormality has been detected.

In a case where the detector that has detected the abnormality is a voltage measuring unit (step S17: voltage measuring unit), the control unit 50 performs a process suitable for an abnormality detected by a voltage measuring unit (step S19). In step S19, if the charge pressure measured by the voltage measuring unit is equal to or higher than a certain level (a predetermined threshold value), the control unit 50 stops the image forming operation, to lower the charge pressure of the charger 35, for example.

If the detected abnormality is not related to ozone (step S16: NO), the control unit 50 determines whether the type of the detected abnormality is a scattered toner abnormality or an unusual odor abnormality (step S20). In the case of a scattered toner abnormality (step S20: scattered toner), the control unit 50 performs a process suitable for an abnormality detected by the particle counter 83 (step S21). In step S21, to reduce the scattered toner, the control unit 50 switches the image formation mode to a low-coverage mode for reducing the amount of toner on paper sheets, and reduces the number of developing operations by lowering the PPM, for example. To have the scattered toner sucked quickly and cause the collector 120 to collect the scattered toner, the control unit 50 also increases the wind speed of the fan F3, switches on operation of the assist fans F2, opens the shutter portions SH2, and closes the shutter portions SH1. It is preferable to switch on the operation of the assist fans F2 and open/close the shutter portions SH1 and SH2 in accordance with the color in which the abnormality has been detected.

In the case of an unusual odor abnormality (step S20: unusual odor), the control unit 50 performs a process suitable for an abnormality detected by the unusual odor detecting sensor 84 (step S22). In step S22, to remove the unusual odor component with the filter unit 126 (the ozone catalyst filter unit 126b (and the activated carbon filter)), for example, the control unit 50 predicts the timing to exchange the filter unit 126 (or the ozone catalyst filter unit 126b (and the activated carbon filter)) with a new one, causes the operation display part 70 to display the predicted information, and transmits, by e-mail, information about the exchange timing to a service person (or to the server device of the service center) via the communicator 90. The service person visits the place of installation of the image forming apparatus 1 as the transmission source of the e-mail, and exchanges the filter unit 126 (or the ozone catalyst filter unit 126b (and the activated carbon filter)) with a new one.

The control unit 50 then acquires detected information from the detector 80, and determines whether the abnormality detection has recovered by determining whether the detected information has recovered from a value equal to or higher than a predetermined threshold value indicating abnormality detection (step S23). More specifically, in step S23, regarding the detector that has detected the abnormality, the control unit 50 determines whether the detected information acquired from the internal humidity sensor 81 has recovered to a lower value than the predetermined threshold humidity indicating abnormality detection, determines whether the detected information acquired from the ozone sensor 82 of each color has recovered to a lower value than the predetermined threshold ozone concentration indicating abnormality detection, determines whether the detected information about the chargers 35 acquired from the voltage measuring unit of each color has recovered to a lower value than the predetermined threshold voltage indicating abnormality detection, determines whether the detected information acquired from the particle counter 83 of each color has recovered to a lower value than the predetermined threshold toner particle value, or determines whether the detected information acquired from the unusual odor detecting sensor 84 has recovered to a lower value than the predetermined threshold butanol concentration indicating abnormality detection.

If there is no abnormality detection recovery (step S23: NO), the process moves on to step S12. If there is an abnormality detection recovery (step S23: YES), the control unit 50 stops the processing being performed in step S14, S15, S18, S19, S21, or S22 (step S24), and ends the first unusual odor prevention process.

As described above, according to this embodiment, the image forming apparatus 1 includes the chargers 35 that charge the photoreceptors 31, and the developing parts 32 that develop toner image son the charged and exposed photoreceptors 31. The image forming apparatus 1 also includes: the detector 80 that detects humidity, ozone generated from the chargers 35, and toner scattered from the developing parts 32; and a processor (the control unit 50, the shutter portions SH1 and SH2, the assist fans F1 and F2, the fan F3, the air separating unit 45, and the operation display part 70) that reduces the humidity, the ozone, or the scattered toner equal to or higher than a predetermined threshold, when at least one of the detected humidity, ozone, and scattered toner is equal to or higher than a predetermined threshold value that is set in advance.

With this structure, it is possible to prevent generation of unusual odor in advance, and unusual odor is not removed after generation thereof. Thus, it is possible to lower the labor costs and the component costs required in removing unusual odor.

In a process of lowering humidity, the control unit 50 also causes the internal heater HE1 to heat the inside of the image forming apparatus 1, causes the air separating unit 45 to blow warm air to the chargers 35, or causes the operation display part 70 to display information about a result of detection. Accordingly, humidity can be automatically or manually lowered (through room temperature and humidity adjustment conducted by the user), and generation of unusual odor can be prevented in advance.

Further, the detector 80 (the ozone sensor 82, and the voltage measuring units of the chargers 35) detects the ozone generated from the chargers 35 and the voltage of the chargers 35. In a case where the detected ozone or the detected voltage becomes equal to or higher than a predetermined threshold value, the control unit 50 performs a process of reducing the ozone. Thus, generation of ozone can be accurately detected.

Further, in a process of reducing ozone, the control unit 50 reduces the number of times (per unit time) charging (discharging) is performed by the chargers 35, to lower the voltage (by stopping image formation). Accordingly, generation of ozone can be effectively reduced, and generation of unusual odor can be effectively prevented.

The image forming apparatus 1 also includes the collection mechanism 100 that collects ozone. In a process of reducing ozone, the control unit 50 performs a process of increasing the amount of ozone to be captured by the collection mechanism 100, by increasing the wind speed of the fan F3, driving the assist fans F1, and closing the shutter portions SH2. Accordingly, generation of ozone can be more effectively reduced, and generation of unusual odor can be more effectively prevented.

The control unit 50 also performs a process of reducing the amount of toner at the developing parts 32 at a time of image formation, as a process of reducing scattered toner. Accordingly, generation of scattered toner can be effectively reduced, and generation of unusual odor can be effectively prevented.

The image forming apparatus 1 also includes the collection mechanism 100 that collects toner. In a process of reducing scattered toner, the control unit 50 performs a process of increasing the amount of toner to be captured by the collection mechanism 100, by increasing the wind speed of the fan F3, driving the assist fans F2, and closing the shutter portions SH1. Accordingly, generation of scattered toner can be more effectively reduced, and generation of unusual odor can be more effectively prevented.

The unusual odor detecting sensor 84 of the detector 80 detects unusual odor. In a case where the detected unusual odor is equal to or higher than a predetermined threshold value that is set in advance, the control unit 50 performs a process of notifying the service person of the timing to exchange the filter unit 126 with a new one through transmission to the server device of the service center via the communicator 90, and notifying the user of the exchange timing through display on the operation display part 70. Thus, the user and the service person can be prompted to perform maintenance such as exchanging the filter unit 126 with a new one without fail.

The control unit 50 also performs a process of reducing humidity, ozone, or scattered toner. In a case where the reduced humidity, ozone, or scattered toner is lower than the corresponding predetermined threshold value, the control unit 50 stops the process of reducing humidity, ozone, or scattered toner. Accordingly, in a case where humidity, ozone, or scattered toner has been appropriately reduced, the state of the image forming apparatus 1 can be promptly recovered.

### 2. Modification

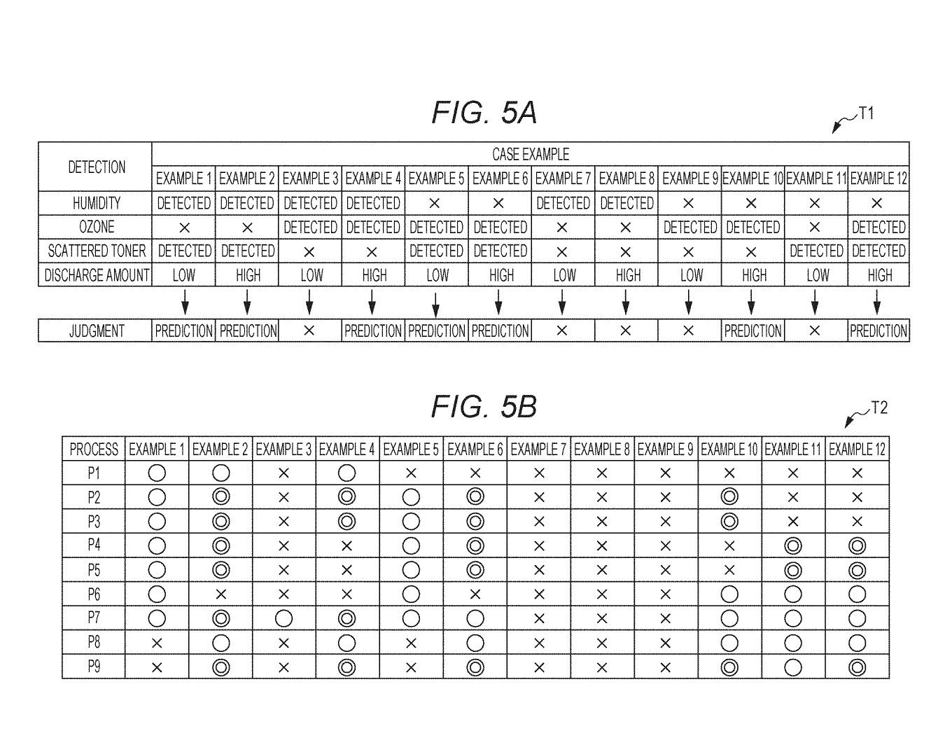

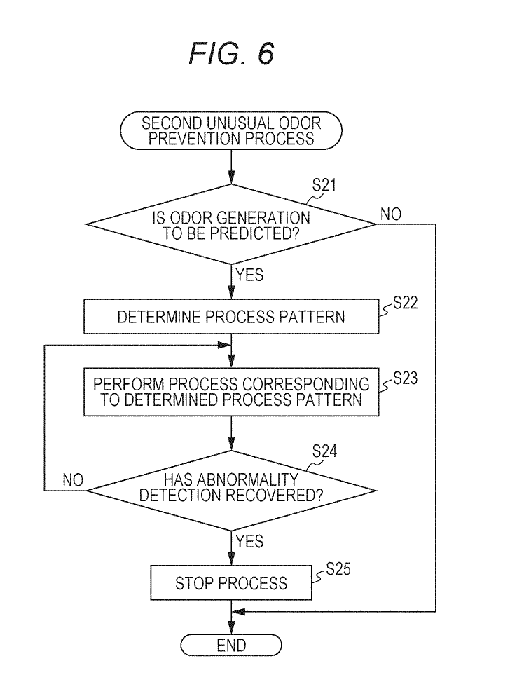

A modification of the above embodiment is now described, with reference to FIG. 5A, FIG. 5B and FIG. 6.

As in the above embodiment, an image forming apparatus 1 is used as an apparatus configuration in this modification. However, the storage unit 60 stores a prediction judgment table T1 and a process table T2, and also stores a second unusual odor prevention program, instead of the first unusual odor prevention program.

### 2-1. Configurations of the Tables

Referring now to FIG. 5A and FIG. 5B, the prediction judgment table T1 and the process table T2 stored in the storage unit 60 are described. FIG. 5A is a diagram showing the prediction judgment table T1. FIG. 5B is a diagram showing the process table T2.

As shown in FIG. 5A, the prediction judgment table T1 includes information about the abnormality detection patterns of Examples 1 to 12 as case examples corresponding to the types of detection to be performed by the detector 80, and information about presence/absence of predictions for unusual odor generation in the respective examples.

In a case where the detection type is “humidity”, the control unit 50 determines whether detected information acquired from the internal humidity sensor 81 is equal to or higher than a predetermined threshold humidity indicating abnormality detection. If the detected information is equal to or higher than the predetermined threshold value, “(abnormality) detected” is shown in the table. In a case where the detection type is “ozone”, the control unit 50 determines whether detected information acquired from the ozone sensor 82 of each color is equal to or higher than a predetermined threshold ozone concentration indicating abnormality detection. If the detected information is equal to or higher than the predetermined threshold value, “(abnormality) detected” is shown in the table.

In a case where the detection type is “scattered toner”, the control unit 50 determines whether detected information acquired from the particle counter 83 of each color is equal to or higher than a predetermined threshold toner particle value indicating abnormality detection. If the detected information is equal to or higher than the predetermined threshold value, “(abnormality) detected” is shown in the table. In a case where the detection type is “discharge amount”, the control unit 50 calculates the discharge amount of each charger 35 from detected information about each charger 35 acquired from the voltage measuring units of the respective colors, and determines whether the calculated discharge amount is “high” or is equal to or higher than a predetermined threshold discharge amount indicating abnormality detection, or determines whether the calculated discharge amount is “low” or is lower than the predetermined threshold discharge amount.

In the prediction judgment table T1, presence/absence of a prediction for unusual odor generation is set, in accordance with a pattern that shows presence/absence of a detected abnormality of the detection type “humidity”, presence/absence of a detected abnormality of the detection type “ozone”, presence/absence of a detected abnormality of the detection type “scattered toner”, and “high”/“low” in the detection type “discharge amount”.

As shown in FIG. 5B, the process table T2 shows the effectiveness of unusual odor prevention by Processes P1 to P9 in Examples 1 to 12 as the case examples shown in the prediction judgment table T1. “⊙” in effectiveness indicates that the effectiveness is very high. “∘” in effectiveness indicates that there is effectiveness. “x” in effectiveness indicates that the effectiveness is poor, and the corresponding process is not to be selected and performed.

Process P1 is a process of reducing the discharge time of the high voltage of the charger 35 of each color of the image forming part 30. Process P2 is a process of reducing the load timing of the high voltage of the charger 35 of each color of the image forming part 30. Process P3 is a process of lowering the toner density and reducing the amount of scattered toner by controlling the developing part 32 of each color, and is performed in a low-coverage mode, for example. Process P4 is a process of setting a toner refresh mode and reducing the amount of scattered toner, by controlling the developing part 32 of each color. The toner refresh mode is a mode in which the toner and the carrier in the developing parts 32 are stirred and refreshed.

Process P5 is a process of lighting up and lowering the humidity in the image forming apparatus 1, by controlling the internal heater HE1. Process P6 is a process of causing the operation display part 70 to display information about a prediction for unusual odor generation, by controlling the operation display part 70. Process P7 is a process of predicting the timing to exchange the filter unit 126 with a new one, and causing the operation display part 70 to display the predicted exchange timing.

Process P8 is a process of causing the operation display part 70 to display information indicating necessity of maintenance of the developer (the toner and the carrier) in the developing part 32 and the charger 35 of the color in which an abnormality has been detected, by controlling the operation display part 70. Process P9 is a process of transmitting information indicating the necessity of maintenance of the developer in the developing part 32 and the charger 35 of the color in which an abnormality has been detected, to the server device of the service center via the communicator 90, by controlling the operation display part 70.

The patterns of Processes P1 to P9 in the process table T2 are merely examples, and Processes P1 to P9 do not necessarily have these patterns. Further, the patterns of Processes P1 to P9 in the process table T2 may be changed in response to an operation input by the user, a service person, or the like via the operation display part 70, or may be changed or set depending on conditions such as time slots.

### 2-2. Operation of the Image Forming Apparatus

Referring now to FIG. 6, operation of the image forming apparatus 1 is described. FIG. 6 is a flowchart showing a second unusual odor prevention process.

The second unusual odor prevention process to be performed during an image forming process or in a standby state in the image forming apparatus 1 is now described, with reference to FIG. 6. The second unusual odor prevention process is a process to of taking measures beforehand to prevent generation of an unusual odor component in a case where the cause of generation of an unusual odor component has been detected. The second unusual odor prevention process is performed at predetermined intervals, for example. In the image forming apparatus 1, with the trigger being the elapse of a predetermined period of time during an image forming process and in a standby state, the control unit 50 performs the second unusual odor prevention process in accordance with the second unusual odor prevention program stored in the storage unit 60.

First, the control unit 50 refers to the prediction judgment table T1 stored in the storage unit 60, to acquire detected information from the detector 80. The control unit 50 then determines whether to predict generation of unusual odor, by determining whether the pattern of abnormality detection and the fluctuation of the discharge amount of the respective types of detection in the detected information corresponds to a pattern (a case example) shown in the prediction judgment table T1 (step S21). More specifically, in step S21, the control unit 50 generates a pattern indicating that there is a detected abnormality and the discharge amount is high or low, in accordance with detected information acquired from the internal humidity sensor 81, the ozone sensor 82, and the particle counter 83, as described above. The control unit 50 then determines whether there is a prediction for unusual odor generation, by comparing the generated pattern with the patterns in the prediction judgment table T1.

If unusual odor generation is not predicted (step S21: NO), the second unusual odor prevention process comes to an end. If unusual odor generation is predicted (step S21: YES), the control unit 50 refers to the process table T2 stored in the storage unit 60, refers to the process corresponding to the pattern (case example) predicted in step S21 among Processes P1 to P9, refers to the prediction selected in step S21 from among Processes P1 to P9, and determines the process pattern corresponding to the pattern (case example) predicted in step S21 (step S22).

The control unit 50 then performs a process corresponding to the process pattern of the process determined in step S22 (step S23). In step S23, the processes with “⊙” and “∘” in the determined process pattern (case example) in the process table T2 are performed, for example. However, the processes to be performed are not limited to such processes.

In the same manner as in step S21, the control unit 50 then acquires the detected information from the detector 80 in accordance with the detection type of abnormality detection (“high” in the discharge amount) in the case example predicted in step S21, acquires the abnormality detection for the respective detection types and the levels (high/low) of the discharge amounts in the detected information, and determines whether the abnormality detection (“high” in the discharge amount) has recovered from step S21 (step S24). If the abnormality detection (“high” in the discharge amount) has not recovered (step S24: NO), the process moves on to step S23.

If the abnormality detection (“high” in the discharge amount) has recovered (step S24: YES), the control unit 50 stops the processing performed in step S23 (step S25), and ends the second unusual odor prevention process.

In this modification, in a case where the filter cost of the filter unit 126 is $10, the machine durability of the image forming apparatus 1 is one million pages, and the regular filter exchange timing is 100,000 pages, it is necessary to exchange filter units nine times within the machine endurance (the first one is mounted at the time of manufacture at the factory), and the labor cost is $90 (=$10/piece×9 exchanges). In a case where the amount of generated unusual odor can be reduced 30% by preliminary abnormality detection of this modification, the number of exchanges decreases to eight, and the labor cost becomes $80. Thus, a $10 reduction in the labor cost is achieved.

As described above, according to this modification, it is possible to prevent generation of unusual odor in advance, and unusual odor is not removed after generation thereof, as in the above embodiment. Thus, it is possible to lower the labor costs and the component costs required in removing unusual odor.

In a process of reducing ozone, the control unit 50 also reduces the charging (discharging) time and the number of times (per unit time) charging (discharging) is performed in the chargers 35, to reduce the ozone to be generated. Accordingly, generation of ozone can be effectively reduced, and generation of unusual odor can be effectively prevented.

The control unit 50 also performs a refreshing process for the developing parts 32 as a process for reducing scattered toner. Accordingly, generation of scattered toner can be effectively reduced, and generation of unusual odor can be effectively prevented.

In a case where the discharge amount corresponding to the detected voltage of the charger 35 is equal to or higher than a predetermined threshold value, the control unit 50 also performs a process of reducing ozone. Thus, generation of ozone can be accurately detected.

The control unit 50 also notifies the user of a result of detection and information about necessity of maintenance as information based on a result of detection of humidity, ozone, or scattered toner, through display on the operation display part 70. Alternatively, the control unit 50 notifies the service person of such information through transmission to the server device of the service center via the communicator 90. Thus, the user and the service person can be prompted to perform maintenance of the image forming apparatus 1 without fail.

The above descriptions of the embodiment and the modification are about examples of preferred image forming apparatuses according to embodiments of the present invention, and do not limit the present invention. For example, the embodiment and the modification may be combined as appropriate.

Further, in the above described embodiment and the modification, the image forming apparatus 1 includes the image forming part 30 of the four colors Y, M, C, and K, and is designed to perform color image formation. With respect to the four colors Y, M, C, and K, the image forming apparatus 1 detects ozone (including the voltage of the chargers 35) and toner. If an abnormality is detected, the image forming apparatus 1 performs a process of reducing humidity, ozone, or scattered toner, using assist fans shutters, and the like. However, the image forming apparatus 1 is not necessarily designed in this manner. For example, ozone (including the voltage of the chargers 35) and toner may be detected with respect to at least one color (such as black, which is frequently used) of the four colors, and, when an abnormality is detected, a process of reducing humidity, ozone, or scattered toner may be performed with assist fans, shutters, and the like. Alternatively, the image forming apparatus 1 may include a black image forming part 30 to perform monochrome image formation, detect the ozone and the toner corresponding to black, and perform a process of reducing humidity, ozone, or scattered toner when an abnormality is detected.

Further, in the above described embodiment and the modification, in a case where the amount of detection performed by the detector 80 becomes lower than a predetermined threshold value after a process of preventing unusual odor is performed, the unusual odor prevention process is stopped. However, this operation is not necessarily performed. For example, after Process P8 is performed, when the exchange of the filter unit 126 with new one is completed, the control unit 50 may stop the display of the information about the necessity of maintenance on the operation display part 70. Alternatively, after Process P9 is performed, and maintenance by a service person is completed, the control unit 50 may stop the transmission of the information about the necessity of maintenance to the server device of the service center via the communicator 90.

Further, at the time of maintenance, the control unit 50 may cause the operation display part 70 to display the number of times action (process execution) has been taken after a prediction.

Further, in the above described embodiment and the modification, the detector 80 detects humidity, ozone, and scattered toner, but the present invention is not limited to this. For example, the image forming apparatus 1 may detect at least one of humidity, ozone, and scattered toner with the detector 80, and perform a process of preventing unusual odor by reducing humidity, ozone, and scattered toner in accordance with the result of the detection.

Further, the control unit 50 of each image forming apparatus 1 may transmit information about the cause of unusual odor and the occurrence status of the unusual odor in at least one image forming apparatus 1, to the server device of the service center via the communicator 90. The server device is then caused to gather the information. The received information is analyzed in the server device, so that information about the unusual odor generated situation in each area and predictions for unusual odor generation is generated and provided. In accordance with the information about predictions, the number of filter units 126 to be produced and distributed are adjusted so as to smoothly respond to the market demand.

Further, the image forming apparatus 1 may also include an image calibrating unit on the downstream side of the fixing unit 40, and the image calibrating unit reads an image formed on a paper sheet and calibrates each component of the image forming apparatus 1. In a case where the image level of an image read by the image calibrating unit is equal to or higher than a predetermined normal image level, the control unit 50 may predict unusual odor and perform a process of taking a measure against the unusual odor. In a case where the image level is lower than the predetermined normal image level, the control unit 50 may transmit maintenance necessity information to the server device of the service center via the communicator 90. In a case where the image calibrating unit is not provided, the user may visually determine the image level of an image formed on a paper sheet. If the image level is lower than the predetermined normal image level, the control unit 50 may transmit the maintenance necessity information to the server device of the service center via the communicator 90, in accordance with an input from the user via the operation display part 70.

Further, modifications may be made to the specific configurations and the specific operations of the respective components constituting the image forming apparatus 1 in the above embodiment, without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a charger that charges a photoreceptor;
a developing part that develops a toner image on the charged and exposed photoreceptor;
a detector that detects at least one of humidity, ozone generated from the charger, and toner scattered from the developing part; and
a processor that performs a process of reducing at least one of the detected humidity, ozone, and scattered toner, when the at least one of the detected humidity, ozone, and scattered toner is equal to or higher than a predetermined threshold value, predetermined threshold values having been set beforehand for humidity, ozone, and scattered toner.

2. The image forming apparatus according to claim 1, wherein
the processor performs at least one of a process of heating an inside of the image forming apparatus and a process of blowing warm air to the charger, as a process of reducing the humidity.

3. The image forming apparatus according to claim 1, wherein
in detecting ozone, the detector performs at least one of detection of the ozone generated from the charger and detection of a voltage of the charger, and
the processor performs a process of reducing ozone, when at least one of the detected ozone, and the detected voltage or a discharge amount corresponding to the detected voltage is equal to or higher than the corresponding predetermined threshold value.

4. The image forming apparatus according to claim 1, wherein
the processor performs a process of reducing at least one of a voltage, a discharging time, and number of times discharging is performed at the charger, as a process of reducing the ozone.

5. The image forming apparatus according to claim 1, further comprising
a first collector that collects the ozone, wherein
the processor performs a process of increasing an amount of ozone collected by the first collector, as a process of reducing the ozone.

6. The image forming apparatus according to claim 1, wherein
the processor performs at least one of a process of reducing a toner amount in image formation at the developing part, and a refreshing process, as a process of reducing the scattered toner.

7. The image forming apparatus according to claim 1, further comprising
a second collector that collects the toner, wherein
the processor performs a process of increasing an amount of toner collected by the second collector, as a process of reducing the scattered toner.

8. The image forming apparatus according to claim 1, wherein
the processor performs a process of issuing a notification of information based on a result of the detection, as a process of reducing at least one of the humidity, the ozone, and the scattered toner.

9. The image forming apparatus according to claim 8, wherein
the processor performs a process of issuing a notification of information about maintenance based on a result of the detection.

10. The image forming apparatus according to claim 9, wherein
the detector detects unusual odor, and
when the detected unusual odor is equal to or higher than a predetermined threshold value, the processor performs a process of issuing a notification of information about maintenance based on a result of the unusual odor detection.

11. The image forming apparatus according to claim 8, wherein
the processor performs at least one of a process of displaying the information based on the result of the detection on a display part, and a process of transmitting the information based on the result of the detection to an external device via a communicator communicably connected to the external device.

12. The image forming apparatus according to claim 1, wherein
the processor performs a process of reducing at least one of the humidity, the ozone, and the scattered toner, and when at least one of the reduced humidity, the reduced ozone, and the reduced scattered toner is lower than the corresponding predetermined threshold value, stops the process of reducing at least one of the reduced humidity, the reduced ozone, and the reduced scattered toner.
